(19) United States
(12) Patent Application Publication
(10) Pub. No.: US 2010/0255315 A1
(43) Pub. Date: Oct. 7, 2010

(54) EPOXY RESIN COMPOSITION

(76) Inventors: Yoshiaki Okabe, Hitachi (JP); Hiroyuki Kagawa, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/751,397

(22) Filed: Mar. 31, 2010

(30) Foreign Application Priority Data
Apr. 1, 2009 (JP) 2009-088806

(51) Int. Cl. B32B 27/38; C08G 59/00; C08L 63/00; C22B 1/00

(52) U.S. Cl. 428/418; 528/100; 524/599; 75/401

(57) ABSTRACT

Provided is an epoxy resin composition which excels in heat resistance properties and electrical properties, and is easily decomposable for the recycling of resources.

The epoxy resin composition includes an epoxy compound and a curing agent, in which at least one of the epoxy compound and the curing agent contains a hydrolyzable tannin having a weight-average molecular weight (Mw) of 500 to 5000.

### CLAIM OF PRIORITY

The present application claims priority from Japanese Patent application serial No. 2009-088806, filed on Apr. 1, 2009, the content of which is hereby incorporated by reference into this application.

### BACKGROUND OF THE INVENTION

1. Field of the Invention

The present invention relates to epoxy resin compositions.

2. Description of Related Art

From the viewpoints of global environmental issues such as global warming, (1) carbon-neutral resins that do not cause increase of carbon dioxide, and (2) resins that enable recycling of various resources have been demanded. Such resins should naturally have various properties such as stability, heat resistance properties, electrical properties and mechanical properties as in the past.

Exemplary carbon-neutral resins include plant-derived biomass resins. Until this point, poly(lactic acid)s (hereinafter simply referred to as “PLAs”) have been predominantly developed for practical use. Concerning the PLAs, corns are raw-materials. And the PLAs are thermoplastic resins.

The PLAs, however, have not yet been adopted to electric components so much, because the raw materials thereof are foodstuffs and they have poor moisture proofness due to their biodegradability.

Accordingly, the current mainstream is to develop resins which use lignins or the like being “inedible resources” and available from ligneous wastes as raw materials and excel in heat resistance properties and moisture proofness. The lignins are primary metabolites, and are organic substances having a polyphenol skeleton. This is because decomposition-controllable resins (whose decomposition is easy to control) have been demanded. Although biodegradable resins such as PLAs decompose very gradually under natural environments, the decomposition-controllable resins are fully stable when used in various components and appliances, but easily decompose under predetermined conditions when their decomposition is needed.

Epoxy resin compositions being thermosetting resin compositions are widely used as encapsulating materials for semiconductor devices.

Patent Document 1 (Japanese Unexamined Patent Application Publication (JP-A) No. 2005-281427) discloses a method for decomposing a cured article of a common petroleum-derived epoxy resin to thereby recycle the decomposed product. This method includes the step of decomposing the cured article in combination with a phenol compound under a supercritical or subcritical condition. However, a large quantity of energy needs to be supplied to adopt such supercritical or subcritical condition practically, and a decomposition method which consumes less energy is still demanded.

If such decomposition method realized, it is possible to easily recover noble metals such as gold and silver typically from semiconductor elements etc. disposed in large quantities. Such noble metals are used as platings or bumps in the semiconductor elements. This technique is therefore advantageous for utilization of “urban mines”.

Patent Document 2 (Japanese Unexamined Patent Application Publication (JP-A) No. 2004-161904) discloses an epoxy resin composition containing an epoxy resin, a specific polyhydric phenol and a flame retardant containing substantially no halogen atom. This technique is intended to provide an epoxy resin composition which excels in flame retardancy, mechanical properties, heat resistance properties, and dimensional stability and is environmentally-friendly. Patent Document 2 further refers to, in the specification, tannic acid, gallic acid, m-galloylgallic acid, and a hydrolyzable soluble tannin having at least one gallic acid and a carbohydrate bonded to each other through ester bonding, as examples of the polyhydric phenol.

Patent Document 3 (Japanese Unexamined Patent Application Publication (JP-A) No. 2003-313676) discloses a non-chromium metal surface-treating agent which consists of a water-soluble zirconium compound and/or water-soluble titanium compound, and a tannin. Patent Document 3 mentions in the specification that the tannin may be a hydrolyzable tannin or a condensed tannin and preferably has a number-average molecular weight of 200 or more.

### SUMMARY OF THE INVENTION

As has been described above, there are known respective techniques such as biomass-derived resins and methods for decomposing epoxy cured articles, but there has been found no technical idea to make full use of these techniques systematically.

Accordingly, an object of the present invention is to provide an epoxy resin composition which excels in heat resistance properties and electrical properties (hereinafter briefly referred to as “excels typically in heat resistance properties etc.”), is easily decomposable to circulate (to recycle) resources, and is less dependent on petroleum.

An epoxy resin composition of the present invention which contains an epoxy compound and a curing agent, in which at least one of the epoxy compound and the curing agent contains a hydrolyzable tannin having a weight-average molecular weight (Mw) 500 to 5000.

### BRIEF DESCRIPTION OF THE DRAWINGS

FIG. 1 is a schematic cross-sectional view showing an embodiment of a ball grid array according to the present invention.

### DETAILED DESCRIPTION OF THE PREFERRED EMBODIMENTS

The present invention relates to plant biomass-derived tannin-containing epoxy resin compositions. Particularly, it relates to epoxy compounds and/or cured articles containing a hydrolyzable tannin; and epoxy resin compositions using them.

An epoxy resin composition according to the present invention contains at least an epoxy compound and a curing agent and may further contain a curing catalytic agent.

Tannins are secondary metabolites widely present in the plant kingdom. They have astringency, are thereby known to tan hides into leather, and are often used for the production of various products. As used herein the term “tannin(s)” is a generic name of water-soluble compounds that react with and are firmly bonded to proteins, alkaloids, and metal ions to form insoluble salts. They are complicated aromatic compounds having a large number of phenolic hydroxyl groups. The tannins are classified into hydrolyzable tannins and condensed tannins. The hydrolyzable tannins are hydrolyzable with an acid or alkali into phenols and alcohols. The condensed tannins are condensed typically by the addition of water.

The hydrolyzable tannins are formed from aromatic compounds including gallic acid and ellagic acid bonded to sugars such as glucose through ester bonding. The condensed tannins are derived from compounds having flavanol skeletons through polymerization.

The present inventors have focused attention on the hydrolyzable tannins. However, commercially available hydrolyzable tannins have widely-ranging weight-average molecular weights (Mw) of several tens of thousands to several hundreds and are partially crosslinked to thereby contain a large amount of components insoluble in organic solvents. Such commercially available hydrolyzable tannins are therefore hard to use in epoxy resin compositions and in vanishes obtained from the epoxy resin compositions.

The present inventors have therefore made intensive investigations to provide a cured article of a tannin-containing epoxy resin composition which has both heat resistance properties and other required properties, and easiness to decompose. As a result, the present inventors have obtained an epoxy resin composition containing a hydrolyzable tannin having a weight-average molecular weight Mw of 500 to 5000 (hereinafter simply referred to as a “low-molecular-weight tannin) through extraction of a commercially available hydrolyzable tannin with an alcohol and/or ether. The present inventors have also found that a cured article of the epoxy resin composition containing the low-molecular-weight tannin excels typically in heat resistance properties and easily decomposes by immersing in a solution of an acid or alkali. The present invention has been made based on these findings.

As used herein an “epoxy resin composition” refers to a precursor of epoxy resin before curing which generally has fluidity (flowability). Also as used herein an “epoxy cured article” refers to a resin cured from the epoxy resin composition under predetermined conditions. An “epoxy cured article” is herein also simply referred to as a “cured article”.

The hydroxyl equivalent weight of the epoxy resin composition is 95 to 97 grams per equivalent. The epoxy resin composition contains an epoxy compound and a curing agent and may further contain a catalytic agent.

A hydrolyzable tannin (low-molecular-weight tannin) for use herein has an ester group in a center region of a tannin skeleton structure (molecular structure of tannin) and a phenolic hydroxyl group in a terminal region of the tannin skeleton structure (molecular structure of tannin). The low-molecular-weight tannin can therefore synthetically give an epoxy compound, because an epoxy group can be added only to (mainly to) the phenolic hydroxyl group using epichlorohydrin and a phase-transfer catalytic agent without decomposing the ester group in the center region. The resulting epoxy compound is also referred to as a “hydrolyzable epoxidized tannin”.

Specifically, in the epoxy resin composition according to the present invention, the constituent epoxy compound preferably contains a hydrolyzable epoxidized tannin which is prepared through epoxidation of the hydrolyzable tannin (low-molecular-weight tannin).

As used herein, a “center region” of the molecular structure of a hydrolyzable tannin refers not to a molecular periphery of a unit structure of the hydrolyzable tannin molecule but to a region around the center of the molecule. Also as used herein a “terminal region” of the molecular structure of a hydrolyzable tannin refers to a molecular periphery of the unit structure of the hydrolyzable tannin molecule.

In the reaction for adding an epoxy group to the hydrolyzable tannin, epichlorohydrin and a phase-transfer catalytic agent tend to react not with the ester group in the center region but with the phenolic hydroxyl group in the terminal region when the epichlorohydrin and the phase-transfer catalytic agent react with the hydrolyzable tannin. This enables addition of epoxy group to the phenolic hydroxyl group in the terminal region.

As used herein the term “hydrolyzable tannin” includes also a hydrolyzable epoxidized tannin.

The low-molecular-weight tannin is also usable as a curing agent, because it has the phenolic hydroxyl group in the terminal region which reacts with an epoxy compound. An epoxy resin composition containing the low-molecular-weight tannin can be formed into a varnish, because the low-molecular-weight tannin is soluble in organic solvents.

Next, a method for decomposing an epoxy cured article will be described.

The epoxy cured article is formed through a crosslinking reaction between an epoxy resin and a phenol resin.

A method for decomposing an epoxy cured article does not decompose a crosslinking group formed as a result of the crosslinking reaction, but decomposes an ester group (located in the center region of the molecular structure of the hydrolyzable tannin), which does not contribute to the reaction with an epoxy group constituting a principal skeleton.

The hydrolyzable tannin for use in the epoxy resin composition according to the present invention will be illustrated below, in comparison with known conventional arts.

Patent Document 2 describes a hydrolyzable soluble tannin formed by bonding at least one gallic acid to a sugar through ester bonding as an example of the polyhydric phenol (polyphenol). Patent Document 2 specifically mentions gallic acid as a constituent of the hydrolyzable soluble tannin but fails to specify the molecular weight of the tannin. The technique disclosed in Patent Document 2 is designed to improve flame retardancy and to reduce load on the environment attendant on improvement of the flame retardancy. That is, the technique utilizes a function of the polyhydric phenol to suppress the decomposition of the epoxy compound upon combustion to thereby improve the flame retardancy.

In contrast, an object of the present invention is to provide an epoxy resin composition which easily decomposes (has easy-degradability) and is derived from a plant biomass, so as to recover and recycle resources such as metals etc. used typically in electronic devices. This technique chooses properties (physical properties) of a resin composition to be used, based on a novel idea which is intended to use a raw material less depending on petroleum and to reuse the resources. This systematic idea is not found in known conventional arts including those described in the documents of prior arts.

Patent Document 3 mentions that the molecular weight of the tannin is preferably 200 or more, but that the tannin may be either a hydrolyzable tannin or a condensed tannin, and the document fails to specify the upper limit of the molecular weight of the tannin. The lower limit of the molecular weight of the tannin in this document is specified so as to avoid a problem that the tannin does not show satisfactory adhesion to a laminate film, if having a molecular weight of less than 200. Patent Document 3 thereby never suggests the idea of the present invention. Additionally, the technique disclosed in Patent Document 3 relates to a non-chromium metal surface-treating agent and differs from the epoxy resin composition according to the present invention in intended use and way to use of tannin.

As is described above, an object of the present invention is to provide an epoxy resin composition which gives a cured article capable of easily decomposing. In contrast, Patent Documents 2 and 3 fail to describe such an object based on a systematic idea as in the present invention, and even the combination of Patent Documents 2 and 3 gives neither idea of the present invention nor idea of adopting a tannin suitable in the present invention to an epoxy resin.

In addition, use of the epoxy resin composition according to the present invention provides a novel method for recovering a metal and a novel method for recycling a metal.

A method for recovering a metal of the present invention includes the steps of immersing an electronic device including a cured article of the epoxy resin composition in a solution of an acid or alkali to decompose the cured article of the epoxy resin composition; removing the decomposed cured article of the epoxy resin composition from the electronic device; and recovering the metal from the electronic device.

A method for recycling a metal according to the present invention includes the steps of producing an electronic device using the epoxy resin composition; immersing the electronic device after being disposed in a solution of an acid or alkali to decompose a cured article of the epoxy resin composition; removing the decomposed cured article of the epoxy resin composition from the electronic device; recovering the metal from the electronic device; and reusing the metal as a resource.

Features of the present invention will be illustrated in detail below.

An epoxy compound according to the present invention is derived from a hydrolyzable tannin as a raw material and is soluble in an organic solvent for the preparation of a varnish.

The weight-average molecular weight (Mw) of the hydrolyzable tannin for use herein is preferably from 500 to 5000. A hydrolyzable tannin may contain a small amount of the ester group, if having a weight-average molecular weight (Mw) less than 500, and it is undesirable from the viewpoint of decomposability of a cured article. In contrast, it is undesirable since a hydrolyzable tannin may show insufficient solubility and may have an excessively high melting point, if having a weight-average molecular weight (Mw) more than 5000.

In an epoxy resin composition according to the present invention, either one or both of the epoxy compound and the curing agent contains a hydrolyzable tannin having a weight-average molecular weight (Mw) of 500 to 5000.

An epoxy resin varnish according to the present invention contains an organic solvent and has an epoxy resin concentration of 5 to 95 percent by weight.

An epoxy resin varnish according to the present invention contains alcohols, ketones or aromatic compounds as the organic solvent.

A method for decomposing an epoxy cured article according to the present invention includes the step of immersing the epoxy cured article in a solution of an acid or base (alkali) to decompose a tannin skeleton.

In the method for decomposing the epoxy cured article, the shear strength between the cured article of the epoxy resin composition and a photosensitive polyimide is preferably 0.3 MPa or less.

The method for decomposing an epoxy cured article may include the step of heating the cured article to a temperature of 70 to 220° C. in a solution of an acid or alkali to thereby decompose a low-molecular-weight tannin.

Exemplary acids usable herein include compounds having a hydrogen ion concentration (pH) of 7 or less, such as hydrochloric acid, acetic acid, and sulfuric acid.

Exemplary alkalis usable herein include compounds having a hydrogen ion concentration (pH) of 7 or more, such as sodium hydroxide, potassium hydroxide, sodium hydrogen carbonate, and tetramethylammonium hydroxide.

Alkalis are advantageous for decomposing an epoxy cured article used typically in an electronic device having a semiconductor element. This is because an acid dissolves a component made from a metal, and the dissolved metallic component is mixed with a dissolved resin if the acid is used.

A semiconductor device according to the present invention includes a semiconductor element which has been sealed with a cured article of the epoxy resin composition.

A method for recovering a metal according to the present invention includes the steps of immersing the semiconductor device in a solution of an acid or alkali to thereby decompose the tannin skeleton of the cured article of the epoxy resin composition used in the semiconductor device; and recovering noble metals such as gold, silver and/or palladium from bumps and platings in semiconductor elements.

In the epoxy resin varnish, examples of the alcohols include 2-methoxyethanol, 2-ethoxyethanol, 2-propoxyethanol and 2-butoxyethanol; examples of the ketones include methyl ethyl ketone, isobutyl ethyl ketone, cyclohexanone, γ-butyrolactone and N,N-dimethylformamide; and examples of the aromatic compounds include toluene, xylenes, and cyclohexanone.

Prepregs are prepared by immersing a base material such as glass cloth or paper with the epoxy resin varnish and drying thereafter are usable for the production of products such as printed circuit boards, electronic devices, and electrical rotating machineries.

It is undesirable that the cured article has inferior properties such as heat resistance properties, stability, and resistance to water absorption because a partial compounding ratio of the epoxy compound to the curing agent deviates from the stoichiometric ratio if the epoxy resin varnish contains the epoxy resin composition as an insoluble material. Thus, it is essential condition that the epoxy resin composition in the present invention should be soluble in an organic solvent.

Because petroleum-derived epoxy compounds and petroleum-derived curing agents have definite chemical structures, epoxy equivalent weights, hydroxyl equivalent weights, amine equivalent weights and molecular weights thereof are clearly measurable. Compounding the petroleum-derived epoxy compounds and petroleum-derived curing agents make it easy to control properties of the epoxy resin composition formed thereof. In addition, most of petroleum-derived compounds are highly soluble in organic solvents.

The petroleum-derived epoxy compounds and petroleum-derived curing agents used in the present invention are preferably those having satisfactory solubility inorganic solvents and sufficient heat resistance properties. Specific examples of petroleum-derived epoxy compounds include bisphenol-A epoxy compounds, bisphenol-F glycidyl ether epoxy compounds, bisphenol-S glycidyl ether epoxy compounds, bisphenol-AD glycidyl ether epoxy compounds, phenol-novolac epoxy compounds, cresol-novolac epoxy compounds, and 3,3′,5,5′-tetramethyl-4,4′-dihydroxybiphenyl glycidyl ether epoxy compounds, although the petroleum-derived epoxy compounds and petroleum-derived curing agents are not limited to the above examples. The epoxy compounds are preferably those containing minimum amounts of ionic substances such as Na⁺ and Cl⁻.

Exemplary petroleum-derived curing agents used in the present invention include amines with linear structure, alicyclic amines, aromatic amines, other amines with cyclic structure, modified amines, acid anhydrides, maleic anhydride, polyhydric phenol curing agents, bisphenol curing agents, polyphenol curing agents, novolac phenol curing agents, and alkylene-modified phenol curing agents. Each of the petroleum-derived curing agents may be used alone or in combination. The curing agents are preferably those containing minimum amounts of ionic substances such as Na⁺ and Cl⁻.

Where necessary, it is possible to use a known curing accelerator generally used for the epoxy resin composition alone, or to compound a plurality of known curing accelerators generally used for the epoxy resin composition as a catalytic agent used in the present invention. Exemplary curing accelerators include tertiary amine compounds, imidazoles, organic sulfines, phosphorus compounds, salts of tetraphenylboron, and derivatives thereof. The amount of curing accelerators is not especially limited, as long as being such an amount as to exhibit a curing-accelerating activity.

Where necessary, the epoxy resin composition according to the present invention may further contain one or more of known coupling agents. Exemplary coupling agents include epoxysilanes, aminosilanes, ureidosilanes, vinylsilanes, alkylsilanes, organic titanates, and aluminum alkylates.

The epoxy resin composition according to the present invention may further contain one or more flame retardants. Exemplary flame retardants include red phosphorus, phosphoric acid, phosphoric acid esters, melamines, melamine derivatives, triazine-ring-containing compounds, cyanuric acid derivatives, nitrogen-containing compounds of isocyanuric acid derivatives, phosphorus-nitrogen-containing compounds such as cyclophosphazenes, metallic compounds such as zinc oxide, iron oxide, molybdenum oxide and ferrocene, antimony oxides such as antimony trioxide, antimony tetroxide and antimony pentaoxide, and brominated epoxy resins. Each of the flame retardants may be used alone or in combination.

The epoxy resin composition may further contain commonly used inorganic fillers.

Such inorganic fillers are used typically for the purpose of improving properties such as hygroscopic property, thermal conductivity and strength and for the purpose of reducing coefficient of thermal expansion. Exemplary fillers include powdery substances typically of fused silica, crystalline silica, alumina, zircon, calcium silicate, calcium carbonate, potassium titanate, silicon carbide, silicon nitride, aluminum nitride, boron nitride, beryllia, zirconia, zircon, fosterite, steatite, spinel, mullite and titania; beads prepared from these powders; and glass fibers.

Further, exemplary inorganic fillers having flame retardancy include aluminum hydroxide, magnesium hydroxide, zinc silicate and zinc molybdate. Each of the inorganic fillers may be used alone or in combination.

If needed, the epoxy resin composition may further contain other resins, catalytic agents for the acceleration of reaction, and/or additives such as flame retardants, leveling agents and defoaming agents.

The epoxy resin composition may further contain an ion trapper for improving moisture resistance and properties at high temperatures (heat resistance properties) of the electronic devices. The ion trapper is not especially limited in its type, and can be some of known ion trappers. Exemplary ion trappers include hydrotalcites; and hydrous oxides of elements such as magnesium, aluminum, titanium, zirconium and bismuth. Each of the ion trappers may be used alone or in combination.

The epoxy resin composition may further contain other additives if needed. Exemplary other additives herein include stress-relaxing agents such as silicone rubber powders; colorants such as dyestuffs and carbon blacks; leveling agents; and defoaming agents.

The epoxy resin composition may be prepared by mixing components (materials) according to any process and/or using any device, as long as the components (materials) can be uniformly dispersed in and mixed with one another. In general, the composition is prepared by weighing predetermined amounts of the materials, and dispersing and mixing them with one another typically using a device such as ball mill, triple roll mill, vacuum stirring machine, pot mill, or hybrid mixer.

The epoxy resin compositions according to the present invention excel typically in solubility and heat resistance properties and can thereby give products with remarkably improved reliability.

In addition, the epoxy resin compositions need to be satisfactorily soluble in a solvent (organic solvent) and are thereby advantageous in the preparation of copper-clad laminates. This is because the preparation essentially includes the step of impregnating a glass cloth with a varnish of an epoxy resin composition.

The epoxy resin composition is also satisfactorily formable by hot forming. Typically, when a sealant containing an epoxy resin composition is charged into gaps (100 μm gaps) in a flip-chip packaged ball grid array (FC-BGA) according to a capillary flow method, the epoxy resin composition may cause filling defect at a corner edge of the chip and bubble entrainment, and this may lead to deterioration in reliability of the resulting semiconductor device if having insufficient formability.

Exemplary products using the epoxy resin composition include copper-clad laminates using a prepreg prepared from the epoxy resin composition; computers and cellular phones including the copper-clad laminates; motors whose coil unit is insulated by the prepreg; and industrial robots and rotating machineries including the motors. Exemplary products further include chip-size packages in which devices are encapsulated with the sealant according to the present invention; and adhesives, coating materials etc. using the biomass-derived epoxy resin compositions.

The present invention will be illustrated in further detail with reference to several working examples below. However, It should be noted that these examples are never construed to limit the scope of the present invention.

Test materials used in the examples are shown below by trade names or abbreviations.

Ta1: Hydrolyzable tannin having a weight-average molecular weight (Mw) of 3000, prepared by extracting a hydrolyzable tannin (Mimoza, supplied by Kawamura & Co., Ltd.) with methanol, and distilling off methanol from the extract under reduced pressure to give the target substance in a yield of 25%.

Ta2: Hydrolyzable tannin having a weight-average molecular weight (Mw) of 700, prepared by extracting Ta1 with tetrahydrofuran, and distilling off tetrahydrofuran from the extract under reduced pressure to give the target substance in a yield of 40%.

Ta3: Hydrolyzable tannin (Mimoza, supplied by Kawamura & Co., Ltd.) which is substantially insoluble and whose weight-average molecular weight (Mw) is immeasurable.

Eta: Epoxidized tannin having a weight-average molecular weight (Mw) of 1350, prepared from Ta2

DDE: 4,4′-Diaminodiphenyl ether (supplied by Wako Pure Chemical Industries Ltd.)

LL: Low-molecular-weight lignin having a weight-average molecular weight (Mw) of 1200

jER828: Bisphenol-A epoxy compound (supplied by Japan Epoxy Resins Co., Ltd., having an epoxy equivalent weight of 190 grams per equivalent)

RE404S: Bisphenol-F epoxy compound (supplied by Nippon Kayaku Co., Ltd., having an epoxy equivalent weight of 165 grams per equivalent)

ESCN-195: Cresol novolac epoxy compound (supplied by Sumitomo Chemical Co., Ltd., having an epoxy equivalent weight of 195 grams per equivalent)

HP850: o-Cresol novolac resin (supplied by Hitachi Chemical Co., Ltd., having an epoxy equivalent weight of 106 grams per equivalent)

P-200: Imidazole curing catalytic agent (supplied by Japan Epoxy Resins Co., Ltd)

KBM-403: Coupling agent (γ-glycidoxypropyltrimethoxysilane, supplied by Shin-Etsu Chemical Co., Ltd.)

MHAC-P: Methyl-3,6-endomethylene-1,2,3,6-tetrahydrophthalic anhydride (supplied by Hitachi Chemical Co., Ltd., having a weight-average molecular weight (Mw) of 178)

Solvent for varnish: 2-Methoxyethanol/methyl ethyl ketone (1:1 (by weight) solvent mixture, both supplied by Wako Pure Chemical Industries Ltd.)

Samples were prepared and tests were conducted according to the following methods.

1. Test Methods

(a) Solubility

The solubility of a sample (each sample prepared in the examples and comparative examples below) was tested by visually observing how the epoxy compound was dissolved at a concentration of 50 percent by weight in a 1:1 (by weight) solvent mixture of 2-methoxyethanol and methyl ethyl ketone. A sample fully dissolved in the solvent mixture was evaluated as having good solubility (Good), and one partially insoluble in the solvent mixture was evaluated as having poor solubility (Poor).

(b) Weight-Average Molecular Weight (Mw)

The weight-average molecular weight (Mw) (in terms of polystyrene) of a sample was measured using the detector Model L-4000 (UV detector; 270 nm) supplied by Hitachi Chemical Co., Ltd. under the following conditions:

Column: Two Gelpak GL-S300 MDT-5 columns

Column temperature: 30° C.

Flow rate: 1.0 mL per minute

Eluent: 1/1 (1) Mixture of DMF and THF, further containing 0.06 M phosphoric acid and 0.06 M LiBr, wherein DMF represents N,N-dimethylformamide; and THF represents tetrahydrofuran.

(c) Epoxy Equivalent Weight

The epoxy equivalent weight of a sample was measured in accordance with a method (the hydrochloric acid/pyridine method) specified in Japanese Industrial Standards (JIS) K 7236.

(d) Hydroxyl Equivalent Weight

The hydroxyl equivalent weight of a sample was measured in accordance with a method specified in JIS K 6755.

(e) Detection of Epoxidation

¹H-NMR spectrum of a sample epoxidized product (Eta) prepared according to a method mentioned below was measured using deuterated dimethyl sulfoxide as a solvent to detect the presence of protons derived from introduced epoxy group from peaks at 2.6 ppm and 2.8 ppm. In addition, a Fourier transform infrared spectroscopy (FT-IR) was performed to demonstrate the presence of epoxy group from the presence of absorption at wavelengths from 905 to 910 cm⁻¹.

(f) Glass Transition Temperature (Tg)

The heat resistance properties of a sample epoxy cured article were evaluated based on the glass transition temperature (Tg) of the sample. Specifically, each of the compositions according to the examples and comparative examples as given in Table 1 was heated from room temperature to 200° C. at a heating rate of 5° C. per minute and cured at 200° C. for one hour to give a film 100 μm thick. The storage modulus E′ and loss modulus E″ of the film were measured using a dynamic mechanical analyzer (DMA) while raising the temperature at a rate of 5° C. per minute, from which tangent delta (tan δ) was determined as the ratio of the loss modulus E″ to the storage modulus E′, and the glass transition temperature (Tg) was determined from the peak temperature of tan δ.

(g) Shear Bond Strength

A sample forming a cured article (as a block) having 4 mm long, 4 mm wide and 1 mm thick on a substrate made of a negative-working photosensitive polyimide (supplied by HD MicroSystems, Ltd., under the trade name PL-H708) was prepared; the shear bond strength (also referred to as shear strength) between the photosensitive polyimide and the epoxy cured article was measured using the Multi-purpose Bondtester (supplied by Dage, Model PC 2400) to evaluate decomposability. In the measurement, a shearing tool was fixed 50 μm above the photosensitive polyimide substrate, and the shear bond strength was measured at a tool speed of 300 micrometers per second (μm/sec).

2. Preparation Method

(h) Synthetic Preparation of Eta

A mixture of 14.0 g (20 millimoles (mmol)) of Ta1, 59.2 g (640 mmol) of epichlorohydrin, and 0.23 g (1.0 mmol) of benzyltriethylammonium chloride was reacted at 100° C. for one hour. After cooling to 30° C., the mixture was combined with 32 g of a 20 percent by weight aqueous sodium hydroxide solution and 0.46 g (2.0 mmol) of benzyltriethylammonium chloride, followed by stirring vigorously at 30° C. for 1.5 hours. The resulting mixture was washed with four portions of 200 milliliters (ml) of water. Unreacted epichlorohydrin was evaporated from the mixture under reduced pressure (40° C., 0.3 mmHg), the residue was washed with isopropyl alcohol, and thereby yielded 9.8 g of a solid powdery Eta. The infrared (IR) spectrum of the product Eta was determined to find that an absorption derived from ester group was observed at 1715 cm⁻¹, and an absorption derived from epoxy group was observed at 905 cm⁻¹. Independently, ¹H-NMR spectrum of Eta was determined to find that peaks of protons derived from epoxy group were present at 2.6 ppm and 2.8 ppm. Eta had an epoxy equivalent weight of 280 grams per equivalent.

The working examples will be illustrated below.

### Examples 1 to 6

A series of varnishes according to Examples 1 to 6 was prepared to have the compositions given in Table 1, and solubilities of the varnishes were evaluated. In the preparation, a curing catalytic agent was added in an amount of 1 percent by weight based on the weight of the epoxy resin composition containing an epoxy compound and a curing agent. An organic solvent was added in an equivalent weight to that of the epoxy resin composition, followed by fully stirring the mixture. Next, glass clothes 100 μm thick were impregnated with the vanishes according to the examples, respectively, and heated in a hot-air oven at 130° C. for a duration of 3 to 12 minutes so as to allow the epoxy resin compositions to be in an intermediate curing stage (B-stage), and thereby yielded non-sticky prepregs. Resin components alone were taken out from the prepregs and pulverized to give powders. The powders were cured using a vacuum press machine, and thereby yielded cured articles having thicknesses of 0.1 to 3 mm. Properties of the cured articles such as glass transition temperature, volume resistivity and shear strength of the cured articles were determined.

The decomposability was evaluated in the following manner. Five pieces of sample for the measurement of shear strength, and 100 ml of a 20 percent by weight aqueous sodium hydroxide solution were encapsulated in a pressure-tight vessel, heated at 100° C. for 4 hours, cooled, washed with water, and dried. Next, the shear bond strength of the sample after decomposition treatment was determined. These results are also shown in Table 1.

### Comparative Examples 1 to 3

Respective properties were determined by the procedures as in the examples.

According to Example 1, a homogeneous cured article was not obtained because Ta3 was not dissolved in the solvent to fail to give a varnish.

According to Comparative Example 2 and Comparative Example 3, varnishes could be prepared, and resulting cured articles had excellent data in glass transition temperature Tg, volume resistivity and shear strength as in the examples. However, these cured articles did not show reduced shear strengths after hydrolysis (decomposition) treatment, indicating that they were not hydrolyzed.

These results relating to the examples demonstrate that epoxy cured articles according to the present invention have excellent heat resistance properties and insulating properties and give epoxy cured articles that show significantly reduced shear strengths after immersing in a solution of a alkali, because ester groups of the epoxy cured articles are decomposed through the immersion.

Next, a copper-clad laminate was prepared using a varnish having the composition as in Example 1.

### Example 7

A copper-clad laminate was prepared using the varnish prepared in Example 1.

Glass clothes each 30-cm-square and 100 μm thick were impregnated with the varnish prepared in Example 1, heated in a hot-air oven at 130° C. for 8 minutes so as to allow the epoxy resin composition to be in an intermediate curing stage (B-stage), and thereby yielded six plies of non-sticky prepregs. The six plies were laid on one another to give a laminate, the laminate was sandwiched between two plies of copper foil each 25 μm thick, heated using a vacuum press machine from room temperature to 200° C. at a heating rate of 5° C. per minute, further held at 200° C. for one hour for complete curing (C-stage), and thereby yielded a copper-clad laminate without defects. The copper-clad laminate had a glass transition temperature Tg of 190° C.

TABLE 1

| | | | | | | | | Properties of cured article | | | |
|---|---|---|---|---|---|---|---|---|---|---|---|
| | Composition | | | | | | | Glass | | | |
| | | | | | Curing | | | transition | Volume | Shear | Shear strength |
| | Epoxy | Part by | Curing | Part by | catalytic | | | temperature | resistivity | strength | after hydrolysis |
| | compound | weight | agent | weight | agent | wt % | Solubility | (° C.) | (Ω · cm) | (MPa) | (MPa) |
| Example 1 | JER828 | 100 | Ta1 | 47.5 | P-200 | 1.0 | Good | 180 | >1 × 10¹⁵ | 98 | <0.3 |
| Example 2 | Eta | 100 | Ta2 | 32.9 | P-200 | 1.0 | Good | 190 | >1 × 10¹⁵ | 88 | <0.3 |
| Example 3 | Eta | 100 | Ta1 | 33.9 | P-200 | 1.0 | Good | 195 | >1 × 10¹⁵ | 92 | <0.3 |
| Example 4 | Eta | 100 | DDE | 17.9 | — | 0 | Good | 185 | >1 × 10¹⁵ | 95 | <0.3 |
| Example 5 | Eta | 100 | MHACP | 63.6 | P-200 | 1.0 | Good | 195 | >1 × 10¹⁵ | 82 | <0.3 |
| Example 6 | ESCN195 | 100 | Ta2 | 47.2 | P-200 | 1.0 | Good | 190 | >1 × 10¹⁵ | 88 | <0.3 |
| Com. Ex. 1 | JER828 | 100 | Ta3 | 50 | P-200 | 1.0 | Poor | — | — | — | — |
| Com. Ex. 2 | JER828 | 100 | DDE | 25.6 | — | 0 | Good | 195 | >1 × 10¹⁵ | 82 | 70 |
| Com. Ex. 3 | ESCN195 | 100 | LL | 77.9 | P-200 | 1.0 | Good | 205 | >1 × 10¹⁵ | 85 | 92 |

### Example 8

### Resin Encapsulating Material

A resin encapsulating material was prepared by kneading an epoxy resin composition using a three-roll mill and a vacuum stirring machine. The composition is as follows.

Initially, 45 g of RE404S, 55 g of ETa, and 120 g of Ta1 were mixed, and the mixture was further combined with the catalytic agent P-200 in an amount of 1.0 percent by weight based on the weight of the epoxy resin composition (i.e., 1% of the total weight of the epoxy resin composition) and the coupling agent KBM-403 in an amount of 2 percent by weight based on the weight of the epoxy resin composition. The mixture was further combined with an ion trapper IWE 500 (supplied by Toagosei Co., Ltd.) in an amount of 1.0 percent by weight based on the weight of the epoxy resin composition, and thereby yielded an epoxy resin composition A.

Next, three types of high-purity spherical fillers were mixed, the mixture was added in an amount of 50 percent by volume to the epoxy resin composition A, and thereby yielded a resin encapsulating material A. The three types of high-purity spherical fillers were SP-4B (supplied by Fuso Chemical Co., Ltd., having an average particle diameter of 5.1 μm), QS4F2 (supplied by Mitsubishi Rayon Co., Ltd., having an average particle diameter of 4.6 μm), and SO25R (supplied by Tatsumori Ltd., having an average particle diameter of 0.68 μm).

The resin sealant A had a glass transition temperature Tg of 190° C. and a shear strength of 23.9 MPa. The resin encapsulating material A, after treated with a alkali, showed a reduced shear strength of less than 0.2 MPa.

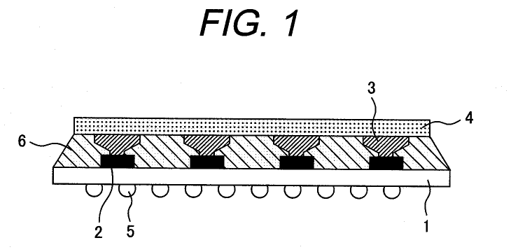

FIG. 1 is a schematic cross-regional view showing an embodiment of a ball grid array according to the present invention, in which the resin sealant A is adopted to a flip-chip packaged ball grid array (FC-BGA).

In FIG. 1, the reference numerals “1” stands for a wiring circuit board (also referred to as “circuit board” or “substrate”), “2” stands for a gold plating, “3” stands for a gold bump (solder bump), “4” stands for a semiconductor element, “5” stands for a solder ball, and “6” stands for a resin sealant. The gold plating 2 of the wiring circuit board 1 and the semiconductor element 4 are coupled to each other through the gold bump 3. A gap between the wiring circuit board 1 and the semiconductor element 4 was sealed by applying the resin sealant 6 thereto and heating the applied resin encapsulating material at 180° C. according to the capillary flow method. The gap was 100 μm and the pitch between bumps (intervals between the adjacent gold bumps 3) was 150 μm. In this way, the resin encapsulant A is applicable to FC-BGA.

Comparisons between the examples and comparative examples demonstrate that the biomass-derived epoxy resins according to the present invention excel in heat resistance properties, electrical properties and shear strength and can have significantly reduced shear strengths as a result of decomposition reactions.

As has been described above, electronic devices such as semiconductor devices can be produced by sealing electronic components such as semiconductor elements with a cured article of the epoxy resin composition. As used herein the “electronic components” include not only integrated circuits, transistors, resistors, capacitors and coils, but also interconnections (wirings) and printed wirings on circuit boards. Each of electronic devices includes one or more electronic components and is composed of an assembly of these electronic components.

The present invention can provide epoxy resin compositions which excel typically in heat resistance properties, are easily decomposable for the recycling of resources, and are less dependent on petroleum.

In addition, the present invention easily recovers metals such as gold, silver and palladium from electronic devices as being disposed.

### EXPLANATION OF NUMERALS

1: wiring circuit board, 2: gold plating, 3: gold bump, 4: semiconductor element, 5: solder ball, 6: resin sealant.

What is claimed is:

1. An epoxy resin composition comprising:
an epoxy compound; and
a curing agent,
wherein at least one of the epoxy compound and the curing agent contains a hydrolyzable tannin having a weight-average molecular weight of 500 to 5000.

2. The epoxy resin composition according to claim 1, wherein the epoxy compound contains a hydrolyzable epoxidized tannin that is the hydrolyzable tannin epoxidized.

3. The epoxy resin composition according to claim 1, wherein the hydrolyzable tannin has an ester group.

4. The epoxy resin composition according to claim 3, wherein the ester group is located in a center region in molecular structure of the hydrolyzable tannin.

5. The epoxy resin composition according to claim 1, wherein the hydrolyzable tannin has a phenolic hydroxyl group.

6. The epoxy resin composition according to claim 5, wherein the phenolic hydroxyl group is located in a terminal region in molecular structure of the hydrolyzable tannin.

7. The epoxy resin composition according to claim 5, wherein the epoxy compound contains the hydrolyzable epoxidized tannin having a molecular structure including an epoxy group added to the phenolic hydroxyl group.

8. An epoxy resin varnish comprising:
the epoxy resin composition according to claim 1; and
an organic solvent.

9. The epoxy resin varnish according to claim 8, which has a concentration of the epoxy resin composition of 5 to 95 percent by weight.

10. The epoxy resin varnish according to claim 8, wherein the organic solvent comprises at least one selected from the group consisting of alcohols, ketones and aromatic compounds.

11. An electronic device comprising an assembly of one or more electronic components containing a metal, wherein the electronic components are sealed with a cured article of the epoxy resin composition according to claim 1.

12. A method for decomposing an epoxy cured article being a cured article of the epoxy resin composition according to claim 1, comprising the step of immersing the epoxy cured article in a solution of an acid or alkali to decompose the epoxy cured article.

13. A method for recovering a metal, comprising the steps of:
immersing the electronic device according to claim 11 in a solution of an acid or alkali, the electronic device including a cured article of the epoxy resin composition, to thereby decompose the cured article of the epoxy resin composition;
removing the decomposed cured article of the epoxy resin composition from the electronic device; and
recovering the metal from the electronic device.

14. A method for recycling a metal, comprising the steps of:
producing the electronic device according to claim 11;
immersing the electronic device in a solution of an acid or alkali after being disposed to thereby decompose the cured article of the epoxy resin composition;
removing the decomposed cured article of the epoxy resin composition from the electronic device;
recovering the metal from the electronic device; and
reusing the metal as a resource.
